(19) United States
(12) Patent Application Publication
(10) Pub. No.: US 2010/0283629 A1
(43) Pub. Date: Nov. 11, 2010

(54) METHODS AND SYSTEMS FOR INCREMENTALLY OBTAINING AN INTERPOLATION OF SENSOR READINGS

(76) Inventors: Bjorn ANDERSSON, Porto (PT); Nuno PEREIRA, Porto (PT); Eduardo TOVAR, Matosinhos (PT); Ricardo GOMES, Alfena (PT)

Correspondence Address: POTOMAC PATENT GROUP PLLC, P. O. BOX 270, FREDERICKSBURG, VA, 22404, US

(21) Appl. No.: 12/774,982

(22) Filed: May 6, 2010

Related U.S. Application Data
(60) Provisional application No. 61/176,549, filed on May 8, 2009.

(51) Int. Cl. H04Q 9/00; H04Q 5/22

(52) U.S. Cl. 340/870.07; 340/10.2

(57) ABSTRACT

A computerized method includes broadcasting, from a node, a request to a plurality of neighboring nodes, the request triggering the plurality of neighboring nodes to contend for access to a medium to transmit information; receiving, in the node, a priority value from each of the plurality of neighboring nodes; determining if the node is a winning node from among the neighboring nodes based on the received priority values and a priority value of the node; granting access to the medium to the node if it is the winning node; and performing an action in the physical world in response to data transmitted from the node if it is the winning node. The node and each of the plurality of neighboring nodes includes at least one sensor. The priority values of the node and of the plurality of neighboring nodes are assigned based on readings of the at least one sensors.

### RELATED APPLICATION

This application is related to, and claims priority from, U.S. Provisional Patent Application Ser. No. 61/176,549, entitled “USING A PRIORITIZED MEDIUM ACCESS CONTROL FOR INCREMENTALLY OBTAINING AN INTERPOLATION OF SENSOR READINGS”, filed on May 8, 2009, the disclosure of which is incorporated herein by reference in its entirety.

### TECHNICAL FIELD

The present invention relates generally to sensor systems and more specifically to communication and processing techniques associated with sensor systems.

### BACKGROUND

As the so-called information or Internet age progresses, the applications for, and capabilities to generate, large amounts of data continue to increase. For example, sensor networks or webs may be created by linking together a large number of sensors or sensor nodes each of which collect data locally associated with one or more physical phenomena. For example, a car could have hundreds or thousands of such sensors embedded in the car body to obtain localized data relating to pressure, temperature and/or deformation of the car body, which information may be processed to determine, for example, when to deploy (i.e., inflate) an airbag. Numerous other applications of such sensor networks are envisioned, some of which are discussed below.

In this context, such a sensor network may be implemented as a set of computer nodes each equipped with a processor, memory, one or more sensors and a transceiver for communications over a (wired or wireless) channel. The sensor network attempts to obtain data from which an accurate “image” or evaluation of a given physical phenomena may be generated and attempts to do so with a high sampling rate in both time and space so that such evaluations may be frequently updated in a localized way. A large number of such computer nodes are needed in order to obtain a high sampling rate in space. However, this generates a large number of sensor readings and, since these sensor readings are generated by different computer nodes, a significant amount of communication may be necessary to gather the data for processing, thus in turn forcing a reduction in the sampling rate in time. For systems with a very large number of computer nodes, it is therefore important to develop techniques that make it possible to obtain a snapshot, i.e., an approximate representation of all sensor readings, and achieve this snapshot with a time-complexity (as a function of the number of nodes) that is small.

One approach for obtaining an approximate representation of sensor readings in such a sensor network is to select a subset of the computer nodes at random and let the sensor readings at those computer nodes be used for obtaining an interpolation. Although this is fast, it has the drawback that some computer nodes with extreme sensor readings may have a significant impact on the interpolation if they were selected, however those computer nodes may not be selected for the subset and this causes the interpolation to be a poor representation of the physical phenomenon and may cause a sensor network to misperceive its physical environment. This problem is discussed in more detail in an article to B. Andersson, N. Pereira, W. Elmenreich, E. Tovar, F. Pacheco, and N. Cruz, entitled “A Scalable and Efficient Approach to Obtain Measurements in CAN-Based Control Systems”, IEEE Transactions on Industrial Informatics, vol. 4, no. 2, pp. 80-91, May 2008, the disclosure of which is incorporated herein by reference in its entirety.

Another approach for obtaining an approximate representation of sensor readings would be to select a subset of the computer nodes which subset is carefully selected to include those nodes which represent local extreme points and let the sensor readings at those computer nodes be used for obtaining an interpolation. If one computer node had knowledge of all sensor readings then such a selection would be possible, but in practice a computer node only knows its own sensor reading (unless other sensor readings are communicated) and therefore it has not been clear how to implement such an approach.

Recent works, including the above-incorporated by reference article to B. Andersson et al., as well as another article to N. Pereira, R. Gomes, B. Andersson, and E. Tovar, entitled “Efficient aggregate computations in large-scale dense WSN,” published in 15th IEEE Real-Time and Embedded Technology and Applications Symposium (RTAS'09), San Francisco, Calif., USA, 2009, the disclosure of which is also incorporated herein by reference in its entirety, have shown how to exploit a prioritized medium access control (MAC) protocol for selecting local extreme points in a sensor network. These articles show how to quickly obtain an interpolation of sensor readings where sensor readings were taken by different computer nodes.

Among other things, the algorithm described in these articles, which exploits a prioritized MAC protocol, has a user-selectable parameter, k, which has the role that the k sensor nodes that contribute the most to the interpolation being a faithful representation of the physical reality being sensed by the sensors are selected and the interpolation is based on those k sensor nodes. The value for k is selected in these articles based on the number of local extrema of the signal. With this approach it was possible to obtain the interpolation with a time-complexity that is independent of the number of sensor nodes (O(k)); yet the result of the interpolation was dependent on all sensor readings.

However, the algorithm described in the above-incorporated by reference articles for obtaining an interpolation of the sensor readings (i) has to run until completion and (ii) was designed to have no prior knowledge of the physical environment. Unfortunately, these aspects of this interpolation algorithm have two corresponding drawbacks. First, there are situations where the delay between when the physical world being monitored by the sensor network changes and when computer system may react to this change is two times the duration required for obtaining the interpolation. This situation occurs when the environment changed just after the algorithm for obtaining the interpolation had started. When this situation arises, the algorithm for obtaining the interpolation must finish execution and then take new sensor readings and finally obtain an interpolation of these new sensor readings, resulting in an undesirable delay between the occurrence of a significant event and the ability of the sensor network to provide an accurate depiction of that event.

A second drawback of this previous interpolation algorithm is that it is necessary that the sampling period of an application that uses this interpolation algorithm have a value of O(k) or greater. If the entire physical environment changes everywhere, it may really be necessary to obtain an interpolation from scratch. But one may expect that a change in the physical environment (such as that caused by a rapid fire, explosion or deformation) has only local effects initially (e.g., during the first milliseconds) and it changes the entire environment later.

Accordingly, it would be desirable to provide an interpolation algorithm, and corresponding sensor network, which uses a sampling rate that is sufficiently high that the sampling period is independent of k and independent of the number of nodes, yet wherein the system is also able to detect extreme local changes with a duration of two sampling periods and obtain an image of the entire physical environment within k sampling periods.

### SUMMARY

According to one exemplary embodiment, a computerized method for incrementally obtaining an interpolation of sensor readings may be provided. The method may be executed on one or more processors. The method may include broadcasting, from a node, a request to a plurality of neighboring nodes, the request triggering the plurality of neighboring nodes to contend for access to a medium to transmit information; receiving, in the node, a priority value from each of the plurality of neighboring nodes; determining if the node is a winning node from among the neighboring nodes based on the received priority values and a priority value of the node; granting access to the medium to the node if it is the winning node; and performing an action in the physical world in response to data transmitted from the node if it is the winning node. The node and each of the plurality of neighboring nodes may include at least one sensor. The priority values of the node and of the plurality of neighboring nodes may be assigned based on readings of the at least one sensors of the node and the plurality of neighboring nodes.

According to another exemplary embodiment, a system for incrementally obtaining an interpolation of sensor readings may be provided. The system may include a medium to transmit information; a node including at least one sensor; and a plurality of neighboring nodes, each including at least one sensor. The node may broadcasts a request to a plurality of neighboring nodes, the request triggering the plurality of neighboring nodes to contend for access to the medium to transmit information. The node may receive a priority value from each of the plurality of neighboring nodes. The node may determine if the node is a winning node from among the neighboring nodes based on the received priority values and a priority value of the node. Access may be granted to the medium to the node if the node is the winning node, and the system may perform an action in the physical world in response to data transmitted from the node if it is the winning node. The priority values of the node and of the plurality of neighboring nodes may be assigned based on readings of the at least one sensors of the node and the plurality of neighboring nodes.

According to another exemplary embodiment, a system for incrementally obtaining an interpolation of sensor readings may be provided. The system may include a medium to transmit information and a plurality of nodes. Each node may include a processor; a memory device connected to the processor; a sensor connected to the processor; and a transceiver connected to the processor to transmit and receive processed sensor data via the medium to transmit information. Periodic sensor readings may be transmitted to the processor for processing resulting in processed sensor data. The transceiver may communicate at least a portion of said processed sensor data via the medium to transmit information based on a prioritized medium access control (MAC) based on a priority. A value of said priority may be assigned based on said at least a portion of the processed sensor data.

### BRIEF DESCRIPTION OF THE DRAWINGS

The accompanying drawings illustrate exemplary embodiments, wherein:

FIG. 1(a) is an example of bitwise arbitration;

FIG. 1(b) is an example of an application where N1 needs to know a minimum temperature reading among its neighbors (N2 to N6);

FIG. 1(c) is an example of a contention resolution solution to the application of FIG. 1(b) using a CAN-like MAC having fixed message priorities;

FIG. 1(d) is an example of a contention resolution solution to the application of FIG. 1(b) using a CAN-like MAC having message priorities are assigned at runtime according to sensed values according to an exemplary embodiment;

FIG. 2(a) is an exemplary signal which varies over space (area);

FIG. 2(b) illustrates the exemplary signal of FIG. 2(a) with noise included;

FIG. 2(c) illustrates a representation of the original signal of FIG. 2(a) using interpolation according to an exemplary embodiment;

FIG. 2(d) depicts a representation of the original signal of FIG. 2(a) using a weighted-average interpolation with randomly selected nodes;

FIGS. 3(a)-3(f) are schematic representations of iterations of an interpolation according to exemplary embodiments of the invention;

FIG. 4 is a schematic representation of an exemplary node which may be used in accordance with exemplary embodiments of the present invention; and

FIG. 5 is a schematic representation of a vehicle including nodes in accordance with an exemplary embodiment of the present invention.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments, when the system starts-up, e.g., is powered on, an interpolation of all of the sensor data may be obtained using the previously known algorithm which is described in the above-incorporated by reference articles. As described above, this step of the process has the time-complexity O(k), which may be larger than desired. However, according to exemplary embodiments, this prior interpolation algorithm may be performed only once. Subsequently, each computer node in the sensor network may have the k sensor readings that may be used to form an interpolation of all sensor readings. The computer nodes may then periodically take sensor readings with a small period between readings. This period between sensor readings may be independent of k and may be independent of the number of computer nodes in the sensor network. The computer nodes may take their sensor readings in parallel and then each computer node may compute the interpolated value itself and compare the newly interpolated value to its own sensor reading. The computer node whose sensor reading contributes the least to the faithfulness of the interpolation may be deselected and the computer node whose sensor reading contributes the most to the faithfulness of the interpolation may be selected.

According to exemplary embodiments, deviations from expected behavior in the physical world (e.g., detecting deformation of mechanical elements in, for example, a car or an aircraft) may be detected quickly in order to enact appropriate actions (e.g., safety actions such as deciding which airbag to inflate, which fuel pump to stop, or which valve to be closed).

Exemplary embodiments may use a prioritized MAC protocol. The MAC protocol may assure that out of all nodes contending for a medium at a given moment, the nodes with the highest priority gain access to the medium. Such an approach may take into account Dominance/Binary-Countdown protocols. Such protocols are discussed in an article by A. K. Mok and S. Ward, entitled “Distributed Broadcast Channel Access”, Computer Networks, vol. 3, pp. 327-335, 1979, the disclosure of which is incorporated herein by reference in its entirety. In Dominance/Binary-Countdown protocols, messages may be assigned unique priorities, and before nodes may try to transmit, the nodes may perform a contention resolution phase (i.e., arbitration) such that the node requesting to transmit the highest priority message succeeds.

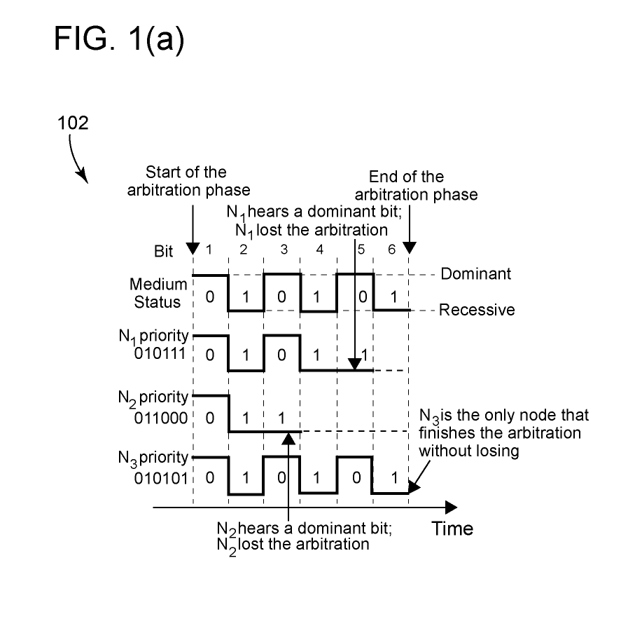

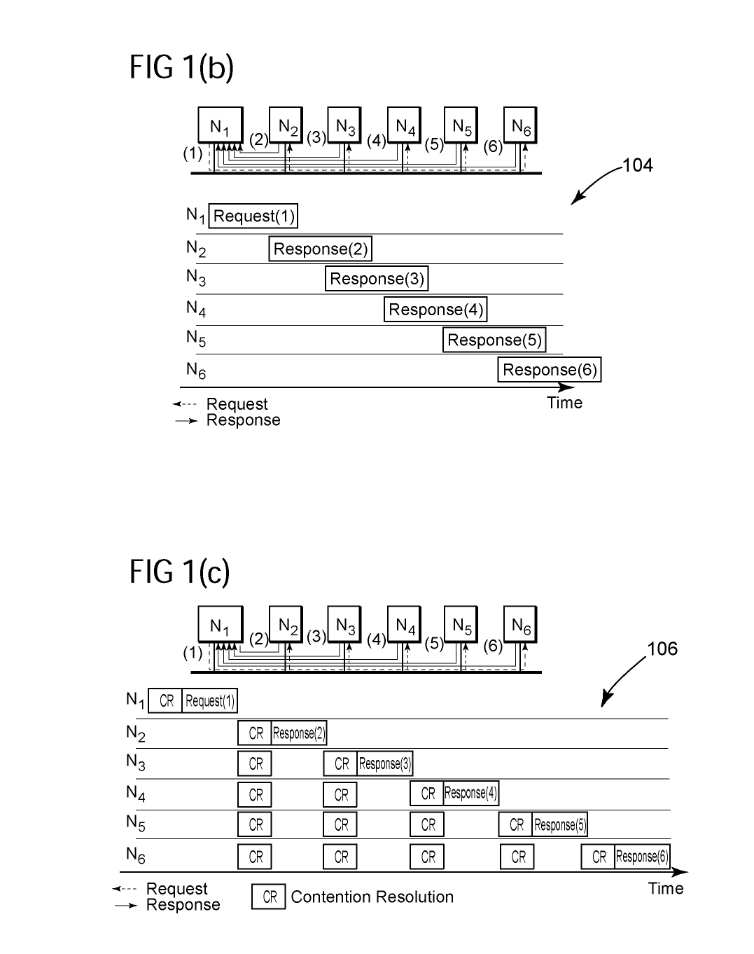

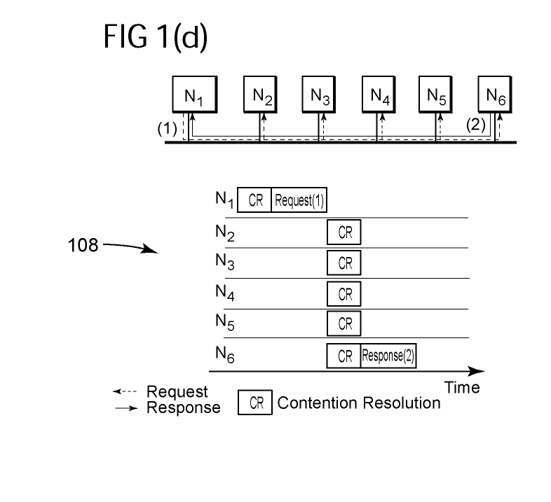

FIG. 1(a) depicts a Controller Area Network (CAN) arbitration of a shared medium, e.g., a bus or interconnect. During the CAN arbitration 102, each node may send a message priority bit-by-bit, starting with the most significant bit, while simultaneously monitoring the medium. The medium may be devised in such a way that nodes may detect a “1” value if no other node is transmitting a “0”. Otherwise, every node may detect a “0” value regardless of what the node itself is sending. For this reason, a “0” may be said to be a dominant bit, while a “1” may be said to be a recessive bit. Therefore, low numbers in a priority field of a message may represent high priorities. If a node contends with a recessive bit but detects a dominant bit, then that node may refrain from transmitting any further bits, and may proceed only monitoring the medium. One node may reach the end of the arbitration phase, and this node (i.e. the winning node) may proceed with transmitting the data part of the message. As a result of the contention for the medium, all participating nodes may have knowledge of the winning node's priority.

An interesting feature of CAN is that the maximum length of a bus may be traded off for lower data rates. It may be possible to have a CAN bus with a bit rate of 1 Mbit/s for a maximum bus length of 30 meters, or a bus 1000 meters long (with no repeaters) using a bit rate of 50 Kbit/s. While the typical number of nodes in a CAN bus may be smaller than 100, with careful design of the network (e.g., selecting appropriate bus-line cross section and drop line length, quality couplers, quality wires, and quality transceivers), it may be possible to go well above this value. For example, CAN networks with more than a thousand nodes have been deployed and they may operate in a single broadcast domain.

One approach for obtaining aggregated quantities in a single broadcast domain is to use a naïve algorithm in which every node broadcasts its sensor reading sequentially, i.e., a naïve algorithm TDMA-like MAC arbitration 104 as shown in FIG. 1(b). In the naïve algorithm TDMA-like MAC arbitration 104, all nodes may know all sensor readings and then they may obtain the aggregated quantity. This approach may include the drawback that in a broadcast domain with m nodes, at least m broadcasts may be required to be performed. In the event of a network designed for, e.g., more than 100 nodes, the naïve algorithm TDMA-like MAC arbitration 104 may be inefficient—it may cause a large delay. For example, in the naïve algorithm TDMA-like MAC arbitration 104 as depicted in FIG. 1(b), a node (node N_{I}) may need to know the minimum (MIN) temperature reading among its neighboring nodes. Assuming no other node attempts to access the medium before node N_{I}, this naïve approach may imply that N₁ may broadcast a request to all its neighboring nodes and then N₁ may wait for the corresponding replies from all of the neighboring nodes. In one example, nodes may orderly access the medium in a TDMA fashion. The initiator node may know the number of neighbor nodes. Then, N₁ may derive a waiting timeout for replies based on this knowledge. With this approach, the execution time may depend on the number of neighboring nodes (m).

Another approach for obtaining aggregated quantities in a single broadcast domain is to use a naïve algorithm in which the priorities the nodes use to access the medium may be ordered according to the nodes' ID, and may be statically defined prior to runtime (i.e., a naïve algorithm CAN-like MAC arbitration 106 shown in FIG. 1(c)). In order to send a message, nodes may have to perform arbitration before accessing the medium. When a node wins, that node may send its response and stop trying to access the medium. As can been observed in FIG. 1(c), using a naïve algorithm CAN-like MAC arbitration 106 may bring no timing advantages as compared to TDMA-like MAC arbitration 104.

Another approach according to an exemplary embodiment for obtaining aggregated quantities in a single broadcast domain is for the nodes to use the value of their sensor readings as their priorities for accessing the medium (sensor priority CAN-like MAC arbitration 108 shown in FIG. 1(d)). The range of the analog to digital converters (ADC) on the nodes may be known, and the MAC protocol may, at least, represent as many priority levels. This may be true as ADCs may have, for example, a data width of 8, 10, 12 or 16-bits while the CAN bus may offer, for example, up to 29 priority bits. With such an approach, to obtain the minimum temperature among its neighbors, node N₁ may need to perform a broadcast request that may trigger all neighboring nodes to contend for the medium using the prioritized MAC protocol. If neighboring nodes access the medium using the value of their temperature reading as the priority, the priority winning the contention for the medium will be the minimum temperature reading. With this approach, more than one node may win the contention for the medium. However, considering that at the end of the arbitration, the priority of the winner may be known to all nodes, no more information may need to be transmitted by the winning node. In this scenario, the time to obtain the minimum temperature reading may only depend on the time to perform the contention for the medium, not on the number of neighbor nodes (m). If, for example, one wishes that the winning node transmits information (such as its location) in the data packet, then one may code the priority of the nodes by adding a unique number (for example, the node ID) in the least significant bits, such that priorities will be unique.

A similar approach may be used to obtain the maximum (MAX) temperature reading. Instead of directly coding the priority with the temperature reading, nodes may use the bitwise negation of the temperature reading as the priority. Upon completion of the medium access contention, given the winning priority, nodes may perform bitwise negation again to know the maximum temperature value.

MIN and MAX are just two examples of how aggregate quantities may be obtained with a minimum message complexity (and therefore time complexity) if message priorities are dynamically assigned at runtime upon the values of a sensed quantity.

### System Model

According to exemplary embodiments, a network may consist of m nodes that may take sensor readings where a node may be given a unique identifier in the range 1 . . . m. MAXNNODES may denote an upper bound on m. MAXNNODES may be known by the designer of the system before run-time. Nodes may not have a shared memory and all data variables may be local to each node.

Each node may include a transceiver and may be able to transmit to or receive from a single channel. Every node may have an implementation of a prioritized MAC protocol with the characteristics as described above. Nodes may perform requests to transmit, and each transmission request may have an associated priority. Priorities may be integers in the range [0, MAX P], where lower numbers may correspond to higher priorities. N_{PRIOBITS} may denote the number of priority bits. This parameter may have the same value for all nodes. Since N^{PRIOBITS} may be used to denote the number of bits used to represent the priority, the priority may be a number in the range of 0 to 2^{NPRIOBITS}−1. MAX P=2^{NPRIOBITS}−1.

As discussed more below, a node may request to transmit an empty packet. That is, a node may request to the MAC protocol to perform the contention for the medium, but not send any data. All nodes may share a single reliable broadcast domain.

A program on a node may access the communication system via the following interface. The SEND system call may take two parameters, one describing the priority of the packet and another one describing the data to be transmitted. If a node calling SEND wins the contention, then it may transmit its packet and the program making the call may unblock. If a node calling SEND loses the contention, then it may wait until the contention resolution phase has finished and the winner has transmitted its packet (assuming that the winner did not send an empty packet). Then, the node may contend for the channel again. The system call SEND may block until it has won the contention and transmitted a packet. The function SEND_EMPTY may take only one parameter, which may be a priority and may cause the node only to perform the contention but not to send any data after the contention. In addition, when the contention is over (regardless of whether the node wins or loses), the function SEND_EMPTY may give the control back to the application and return the priority of the winner.

The system call SEND_AND_RCV may take two parameters, priority and data to be transmitted. The contention may be performed with the given priority and then the data may be transmitted if the node wins. Regardless of whether the node wins or loses, the system call may return the priority and data transmitted by the winner and then unblock the application.

A node Nᵢ may take a sensor reading sᵢ. The sensor reading may be an integer in the range [0, MAX S]. MAX S may be less than or equal to MAX P.

Obtaining an interpolation of sensor readings is now discussed with reference to pseudo code. This pseudo code is presented with respect to three algorithms.

Algorithm 1 Finding a subset of nodes to be used in WAI

Require: All nodes start Algorithm 1 simultaneously.
Require: k denotes the desired number of interpolation points.
Require: A node Nᵢ knows xᵢ, yᵢ, and sᵢ.
Require: The code below is executed by every node. A node can read the
variable i and obtain its node index.
Require: (MAXS+1) x (MAXNNODES+1) + MAXNNODES ≦ MAXP.

| | |
|---|---|
| 1: | function find_nodes( ) return a set of packets |

| | |
|---|---|
| 2: | S ← Ø |
| 3: | for q ← 1 to k do |

| | |
|---|---|
| 4: | Calculate f(xᵢ,yᵢ) in Equation 3 and assign it to the |
| | variable “myinterpolatedvalue” |
| 5: | Error ← abs( sᵢ − to_integer(myinterpolatedvalue) ) |
| 6: | temp_prio ← error x (MAXNNODES + 1) + i |
| 7: | prio ← (MAXP+1) − temp_prio |
| 8: | snd_pack ← < sᵢ,xᵢ,yₗ> |
| 9: | <winning_prio, rcv_pack> ← send_and_rev (prio, |
| | snd_pack) |
| 10: | S ← S ∪ {rcv_pack } |

| | |
|---|---|
| 11: | end for |
| 12: | return S |
| 13: | end function |

Assuming that nodes may take sensor readings, and that a node N knows its location given by two coordinates (xᵢ,yᵢ), it may be possible to obtain an interpolation of sensor data over space. This may offer a compact representation of the sensor data and it may be used to compute virtually anything.

The function ƒ(xᵢ,yᵢ) may denote the function that may interpolate the sensor data. eⱼ may denote the magnitude of the error at node Nj; that is:

eⱼ=|sⱼ−f(xⱼ,yⱼ)| (1)

and e may denote the global error; that is:

$$e = {max}_{j = 1 … m} {e}_{j} \qquad ( 2 )$$

A goal may be to find ƒ(x,y) that minimizes e subject to the following constraints: (i) the time required for computing ƒ at a specific point should be low; and (ii) the time required to obtain the function ƒ(x,y) from sensor readings should be low. The second constraint may be motivated by the fact that it may be interesting to track physical quantities that change quickly; it may be necessary to update the interpolation periodically in order to track, for example, how the concentration of hazardous gases move. For this reason, weighted-average interpolation (WAI) may be used. WAI is discussed in more detail in an article to D. Shepard, entitled “A two-dimensional interpolation functionality for irregularly-spaced data”, Proceedings of the 1968 23^{rd} ACM National Conference, 1968, pp. 517-524, the disclosure of which is incorporated herein by reference in its entirety. WAI may be defined as:

$$f ( x , y ) = \{ \begin{matrix}0 & if S = ∅ ; \\ {s}_{j} & if {N}_{j} ∈ S \text{:} {x}_{j} = x ⋀ {y}_{j} = y ; \\ \frac{{\sum }_{j ∈ S} {s}_{j} \cdot {w}_{j} ( x , y )}{{\sum }_{j ∈ S} {w}_{j} ( x , y )} & otherwise .\end{matrix} \qquad ( 3 )$$

where S may be a set of nodes used for interpolation. The weights wⱼ(x, y) may be given by:

$${w}_{j} ( x , y ) - \frac{1}{{( {x}_{j} - x )}^{2} + {( {y}_{j} - y )}^{2}} \qquad ( 4 )$$

Intuitively, equations [3] and [4] state that the interpolated value may be a weighted average of all data points in S and the weight may be the inverse of the square of the distance. There may be many possible choices on how the weight should be computed as a function of distance. In an embodiment, the choice selected may avoid calculations of square root in order to make the execution time small on platforms that may lack hardware support for floating point calculations. As noted in an article by J. Polastre, R. Szewczyk, and D. Culler, entitled “Telos: Enabling ultra-low power wireless research,” in Proceedings of the Fourth International Conference on Information Processing in Sensor Networks: Special track on Platform Tools and Design Methods for Network Embedded Sensors (IPSN/SPOTS'05), IEEE Computer Society, 2005, pp. 364-369, the disclosure of which is incorporated herein by reference in its entirety, this may be the case for typical sensor network platforms

The original version of weighted-average interpolation, as discussed in the above-incorporated by reference article to D. Shepard, may use all available sensor readings for interpolation. However, this may imply that computing Equation (3) from sensor readings has a time complexity of O(m). Fortunately, as noted in an article to C. Guestrin, P. Bodik, R. Thibaux, M. Paskin, and S. Madden, “Distributed regression: an efficient framework for modeling sensor network data,” in Proceedings of the Third International Conference on Information Processing in Sensor Networks (IPSNO4), 2004, the disclosure of which is incorporated herein by reference in its entirety, it is often the case that sensor readings exhibit spatial locality; that is, nodes that are close in space may give similar sensor readings. For this reason, the interpolation may offer a low error even if only a small number of carefully selected nodes are in S.

Hence, a goal may be to find those nodes that contribute to producing a low error in the interpolation as given by Equation (3). A number of k nodes that may contribute to lowering the error of the interpolation may be selected, where k may be a parameter of the algorithm that may control the accuracy of the interpolation. As noted above, a prioritized MAC protocol may find the maximum among sensor readings. This feature may be exploited to find k nodes that offer a low error value. The proposed distributed algorithm may start with an interpolation being a flat surface and then perform k iterations, where at each iteration, the node with largest magnitude of the error between its sensor reading and the interpolated value may be the winner of the contention.

Algorithm 1 may compute (line 5) the error. This error may be concatenated with the identifier of the node (together this may form the priority of the message) ensuring that all priorities are unique. All nodes may send their messages in parallel (on line 9) and one may win the contention. As discussed above, when nodes call send_and_rcv, then both the priority of the winner and the data transmitted by the winner may be returned to the application on every node. This packet may be added (line 10) to the set S, which may keep track of all received packets related to the problem of creating an interpolation.

Algorithm 1 described above may obtain an interpolation from scratch every time it is run. As mentioned above, this may result in, for example, two drawbacks. To counter those drawbacks algorithm 2 according to an exemplary embodiment is presented below.

Algorithm 2 Algorithm for finding a subset of nodes to be used in WAI

Require: All nodes start Algorithm 2 simultaneously.
Require: k denotes the desired number of interpolation points.
Require: A node Nᵢ knows xᵢ, yᵢ and Sᵢ.
Require: The code below is executed by every node. A node can read the variable i and obtain

its node index.

Require: (MAXS+1) x (MAXNNODES+1) + MAXNNODES ≦ MAXP.

| | |
|---|---|
| 1: | all nodes take sensor readings; the sensor reading at computer node Nⱼ is sⱼ. |
| 2: | call find_nodes (in Algorithm 1) and let S denote the set that is returned |
| 3: | while (true) do begin |

| | |
|---|---|
| 4: | all nodes take sensor readings; the sensor reading at computer node Nⱼ is Sⱼ |
| 5: | for each element in S, there is a time when it most recently became a member in S, pick |

the element with the earliest such time and call it OLDNODE

| | |
|---|---|
| 6: | S ← S \ OLDNODE |
| 7: | if Nᵢ ∈ S then |

| | |
|---|---|
| 8: | Calculate f(xᵢ,yᵢ) in Equations 3 and 4 based on S \ {Nᵢ } and assign it to the variable |

“myinterpolatedvalue”.

| | |
|---|---|
| 9: | else |

| | |
|---|---|
| 10: | Calculate f(xᵢ,yᵢ) in Equations 3 and 4 based on S and assign it to the variable |

“myinterpolatedvalue”.

| | |
|---|---|
| 11: | end if |
| 12: | error ← abs (sᵢ − to_integer(myinterpolatedvalue) ) |
| 13: | temp_prio ← error x (MAXNNODES + 1) + i |
| 14: | prio (MAXP+1) − temp_prio |
| 15: | snd_pack ←< sᵢ,xᵢ,yₗ> |
| 16: | <winning_prio, rcv_pack> ← send_and_rcv( prio, snd_pack) |
| 17: | S ← S ∪ { rcv_pack } |

| | |
|---|---|
| 18: | end while |

Algorithm 2 shows a new interpolation approach as pseudo-code. The algorithm may work as follows. First, Algorithm 1 may be called and this may give a set S with the selected data points. Then, Algorithm 2 may execute lines 4-17 periodically. The execution of lines 4-17 may differ from Algorithm 1 in two respects. First, only one data point may be selected instead of k data points. Second, the computation of lines 4-17 may begin by removing one element in S (lines 5-6) and then a new element may be added (line 17). The rationales for these adding and deleting rules may be as follows. There may be a desire to find the computer node whose sensor reading may contribute the least to a faithful representation of the physical world. It may be possible to find such node out using the prioritized MAC protocol but this may require some communication. Instead, the node which was added to S least recently may be simply removed (lines 5-6). Then line 17 may add the element that contributes the most to a faithful representation of the physical world.

Two cases that may occur may be distinguished. One case may be that the element removed (lines 5-6) and the element added (line 17) are the same. This may occur when the new sensor readings obtained at line 4 changed very little. Another case may be that the element removed (lines 5-6) and the element added (line 17) are not the same. This occurs when the new sensor readings obtain at line 4 changed significantly and therefore it may be necessary that the set S may be modified to reflect the changes in the physical environment.

It should be noted that the lines 4-17 may be executed very quickly; only one transmission (line 16) may be needed. However, executing line 8 and line 10 may have time-complexity O(k) and this may be undesirable. Accordingly, Algorithm 3 is presented which may avoid this potential performance bottleneck.

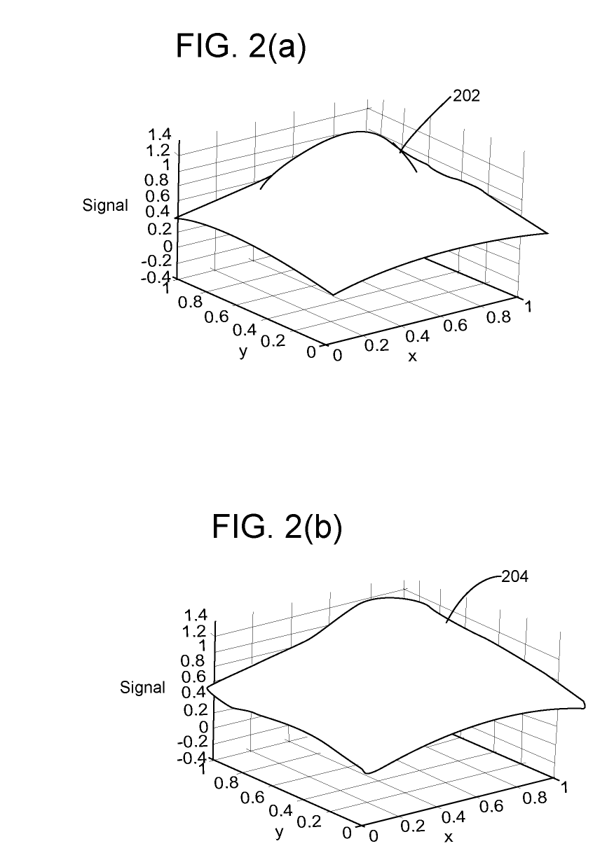

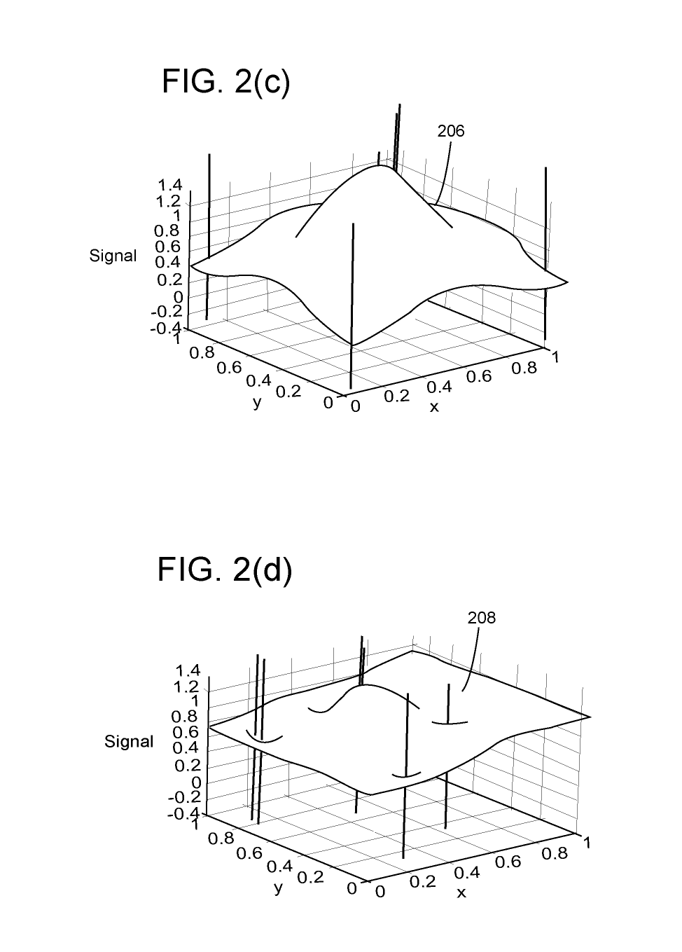

The benefits of selecting a set of nodes for inclusion in a weighted average interpolation using the afore-described exemplary embodiment can be shown via illustration. For example, FIGS. 2(a)-2(d) illustrate the importance of point or node selection in the final interpolation result. FIG. 2(a) shows an original signal 202, with FIG. 2(b) depicting that signal plus noise. In interpolation 206, FIG. 2(c) algorithm 2 is applied to generate a subset of nodes to be used to generate the illustrated interpolation. The location of the subset of k=6 nodes that are selected to be used in the interpolation are indicated with vertical lines in FIG. 2(c).

By way of contrast, in interpolation 208 (FIG. 2d), nodes are randomly selected. Comparison of the interpolation results of FIG. 2(c) and FIG. 2(d) with the original signal or signal plus noise in FIGS. 2(a) and 2(b), respectively, illustrate how algorithm 2 provides an interpolation result 206 may be smooth and tracks well the original signal. In contrast, performing weighted-average interpolation 208 with 6 randomly selected nodes gives a relatively poor interpolation by comparison.

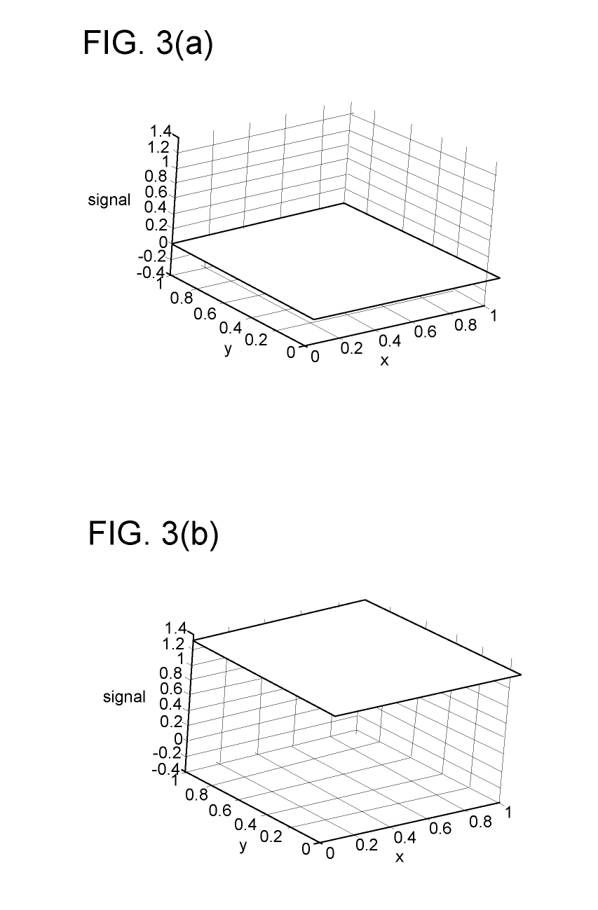

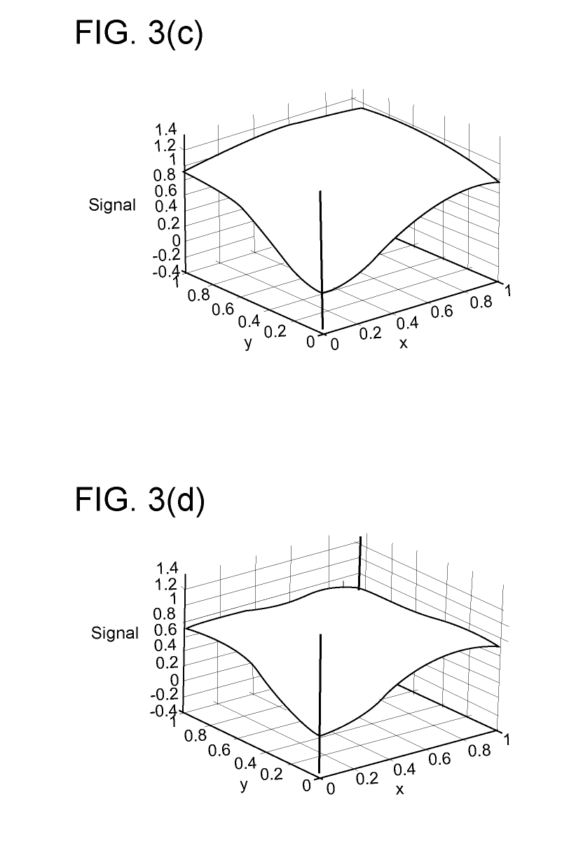

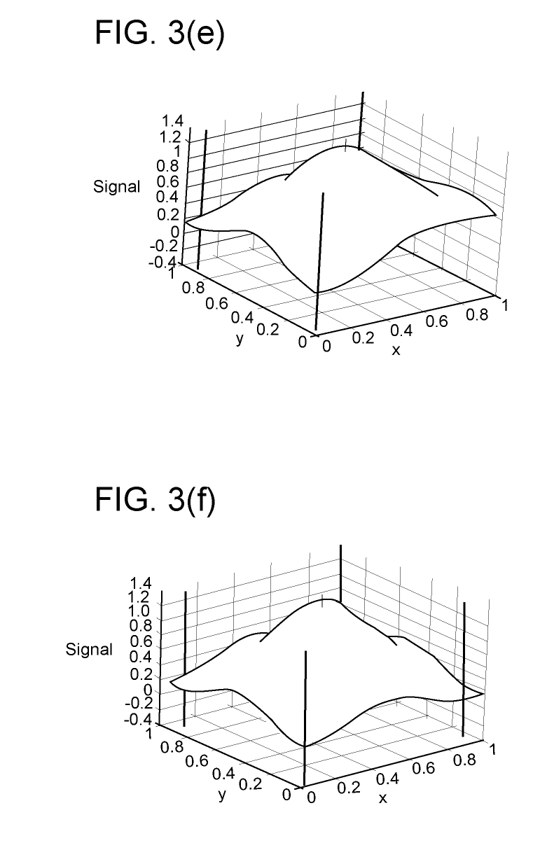

FIGS. 3(a)-3(f) show interpolation iterations using 0-5 points (nodes) in Algorithm 2, respectively. At the beginning of the process (FIG. 3(a)), there is no point in S and, therefore, ƒ(x,y) is a plane surface. Then, each node calculates the error between its sensor reading and the starting plane surface shown in FIG. 3(a). This error is used in the contention of the MAC protocol, causing the node with the largest error to win, and thus, it is inserted into S, resulting in FIG. 3(b) with one point. The process continues similarly through points (nodes) 2-4 (FIGS. 3(c)-3(e), with each node calculating their error relative to the current, interpolated surface and adding the node with the largest error to the cumulative interpolation, until the set S has k points. When this occurs, the final interpolation, in this example for k=6, is shown as FIG. 3(f).

Evaluating ƒ(xᵢ,yᵢ) may be performed quickly and easily if Nᵢ∈S. The result may be simply sᵢ as may be seen in Equation 3. Evaluating ƒ(xᵢ,yᵢ) quickly for the case Nᵢ∉S may require additional modifications (to Algorithm 2). It is noted that each iteration of lines 4-17 (of Algorithm 2) may evaluate ƒ(xᵢ,yᵢ) based on elements in the set S. Since this set may have k elements, each of these evaluations may have a time-complexity O(k). As noted with respect to Equation 3, for this more complex case currently discussed, ƒ (xᵢ, y) may be defined as:

$$f ( {x}_{i} , {y}_{i} ) = \frac{{\sum }_{j ∈ S} {s}_{j} \cdot {w}_{j} ( {x}_{i} , {y}_{i} )}{{\sum }_{j ∈ S} {w}_{j} ( {x}_{i} , {y}_{i} ) } \qquad ( 5 )$$

numᵢ and dcnomᵢ may be defined as:

$$\begin{matrix}{num}_{i} = {\sum }_{j ∈ S} {s}_{j} \cdot {w}_{j} ( {x}_{i} , {y}_{i} ) \\ and & ( 6 ) \\ {denom}_{i} = {\sum }_{j ∈ S} {w}_{j} ( {x}_{i} , {y}_{i} ) & ( 7 )\end{matrix}$$

Accordingly, for this more complex case, write ƒ(xᵢ,yᵢ) as:

$$f ( {x}_{i} , {y}_{i} ) = \frac{{num}_{i}}{{denom}_{i}} \qquad ( 8 )$$

ƒ(xᵢ,yᵢ) on line 8 or line 10 in Algorithm 2 may be evaluated by calculating ƒ(xᵢ,yᵢ) from Equation 8. The values numᵢ and denomᵢ may be updated whenever the set S may change. Therefore, when a new node is added to S, an extra term is simply added to numᵢ and denomᵢ. Similarly, removing a node from S may require that a term is subtracted. Based on these considerations, the exemplary embodiment of Algorithm 2 described above may be modified to generate the exemplary embodiment of Algorithm 3 below.

Algorithm 3 Modified version of algorithm for
finding a subset of nodes to be used in WAI

Require: All nodes start Algorithm 3 simultaneously.
Require: k denotes the desired number of interpolation points.
Require: A node Nᵢ knows xᵢ,yᵢ and sᵢ.
Require: The code below is executed by every node. A node can read the

variable i and obtain its node index.

Require: (MAXS+1) x (MAXNNODES+1) + MAXNNODES ≦ MAXP.

| | |
|---|---|
| 1: | all nodes take sensor readings; the sensor reading at computer node |
| | Nⱼ is sⱼ. |
| 2: | call find_nodes (in Algorithm 1) and let S denote the set that is |
| | returned |
| 3: | if Nᵢ, ∈ S then |

| | |
|---|---|
| 4: | I_am_in_S ← true |

| | |
|---|---|
| 5: | else |

| | |
|---|---|
| 6: | I_am_in_S ← false |

| | |
|---|---|
| 7: | end if |
| 8: | num ← 0 |
| 9: | denom ← 0 |
| 10: | for each Nⱼ ∈ S \ {Nᵢ} do |

| | |
|---|---|
| 11: | num ← num + sⱼ · wⱼ (xᵢ, yᵢ) |

| | |
|---|---|
| 12: | end for |
| 13: | for each Nⱼ ∈ S \ {Nᵢ} do |

| | |
|---|---|
| 14: | denom ← denom + wⱼ (xᵢ,yᵢ) |

| | |
|---|---|
| 15: | end for |
| 16: | while (true) do begin |

| | |
|---|---|
| 17: | all nodes take sensor readings; the sensor reading at |
| | computer node Nⱼ is sⱼ. |
| 18: | for each element in S, there is a time when it most recently |
| | became a member in S, pick the element with the earliest such |
| | time and call it OLDNODE |
| 19: | S ← S \ OLDNODE |
| 20: | if Nᵢ = OLDNODE then |

| | |
|---|---|
| 21: | I_am_in_S 4— false |

| | |
|---|---|
| 22: | else |
| 23: | j ← OLDNODE |

| | |
|---|---|
| 24: | num ← num + sⱼ · wⱼ (xⱼ, yᵢ) |

| | |
|---|---|
| 25: | denom ← denom + wⱼ (xᵢ, yᵢ) |
| 26: | end if |
| 27: | if I_am_in_S then |

| | |
|---|---|
| 28: | myinterpolatedvalue ← sᵢ |

| | |
|---|---|
| 29: | else |

| | |
|---|---|
| 30: | myinterpolatedvalue ← numᵢ/denomᵢ |

| | |
|---|---|
| 31: | end if |
| 32: | error ← abs(sᵢ − to_integer(myinterpolatedvalue) ) |
| 33: | temp_prio ← error x (MAXNNODES + 1) + i |
| 34: | prio (MAXP+I) − temp_prio |
| 35: | snd_pack ←< sᵢ, xᵢ, yᵢ> |
| 36: | <winning_prio, rcv_pack> ← send_and_rcv( prio, snd_pack) |
| 37: | S ← S ∪ { rcv_pack } |
| 38: | if winning_prio=prio then |

| | |
|---|---|
| 39: | I_am_in_S ← true |

| | |
|---|---|
| 40: | else |

| | |
|---|---|
| 41: | j ← the node in rcv_pack |
| 42: | num ← num + sⱼ · wⱼ (xᵢ, yᵢ) |
| 43: | denom ← denom + wⱼ (xᵢ, yᵢ) |

| | |
|---|---|
| 44: | end if |

| | |
|---|---|
| 45: | end while |

Algorithm 3 may be a modified version of Algorithm 2. Execution of lines 17-44 may be independent of m and also independent of k. Each line may execute very quickly. In particular, it is noted that line 36, send_and rev, may be executed, for example, within 3 milliseconds if the hardware platform from the above-incorporated by reference article to N. Pereira et al. is used. Because execution of lines 17-44 may be performed at such a high speed, it may be possible to build a sensor network that monitors its environment by obtaining an interpolation as a representation of the physical world and obtain an update of that interpolation very quickly. Any extreme localized change in the physical environment may be detected and its position may be found, for example, within just 3 milliseconds. Future hardware developments may further speed up the process.

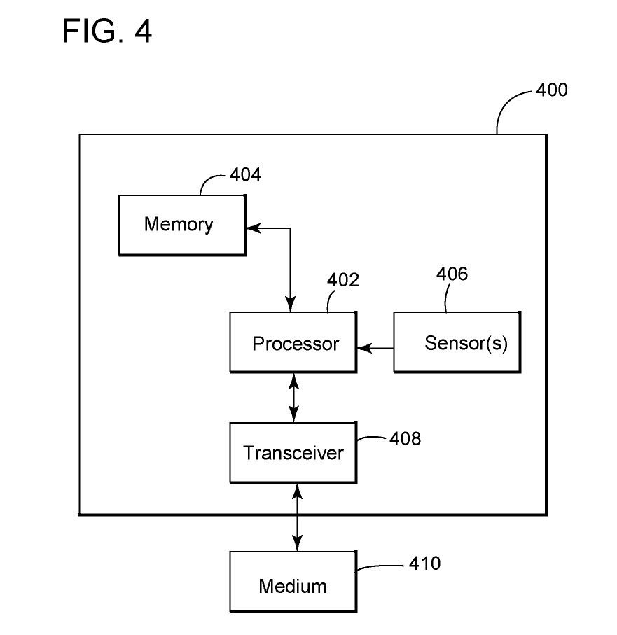

FIG. 4 is a schematic representation of an exemplary node which may be used in accordance with exemplary embodiments described above. For example, node 400 may include a processor 402, a memory device 404 connected to the processor 402, a sensor or plurality of sensors 406 connected to the processor 402, and a transceiver 408 connected to the processor 402 for transmitting and receiving processed sensor data. The transceiver 408 may be connected to a medium 410 for transmitting such information, which medium may be wireless, e.g., interface, or wireline, e.g., optical fiber. The sensor or sensors 406 may transmit periodic sensor readings to the processor 402 for processing as described above. The transceiver 408 may then communicate those processed readings as they are received from processor 102 based upon a prioritized medium access control protocol (MAC) as described above. The prioritized MAC protocol may, for example, be either a collision-free protocol or a collision-not-free protocol. If a prioritized collision-not-free protocol is selected for the MAC layer, then it may be expected that when a collision occurs transmission may be retried. Another characteristic of a prioritized MAC protocol according to these exemplary embodiments is that all of the nodes 400 which are present in the system may know the priority of the winning node, that is each node may know when it's time is to transmit and/or whose turn it is to transmit among the various nodes 400 in the system. Another quality of prioritized MAC protocols according to these exemplary embodiments are the number of priority levels which may be available within the system.

Since the exemplary embodiments are intended to facilitate interpolation of the sensor readings, the prioritized MAC protocol may preferably have a number of priority levels which is quite large. For example, the number of priority levels may be related to the number of bits which are used to represent sensor information and to the number of sensors which are being used in the system. For example, if each sensor 406 uses eight bits to transmit each sensor reading to processor 402, and there are 1,000 sensor nodes 400 in the system, then there may be 218 priority levels in a prioritized MAC protocol which may be used to transmit information from transceiver 408 to medium 410 according to some exemplary embodiments. Recognizing that this is a purely illustrative example, the 218 number of priority levels can be calculated as 8 bits of sensor granularity+log 1000 (i.e., the number of sensor nodes in the system), which equals 18 bits. The aforedescribed CAN protocol may be an example of a prioritized MAC protocol which can be selected for this purely illustrative sensory web since it may provide 29 bits of priority or 229 priority levels.

There are number of applications in which sensory webs including a large number, e.g., thousands, tens of thousands, hundreds of thousands, or even a million such nodes 400 may be deployed. According to some exemplary embodiments, the area within which such sensory webs may be deployed may be relatively small such that latency associated with communicating sensor readings between the various nodes may be sufficiently small to enable interpolation of the readings sufficiently quickly. Additionally, the transceiver 408 may be a transceiver which may enable the node 400 to transmit and receive on the same channel at the same time (e.g., if the medium 410 is a wireline or non-wireless medium) or to switch very quickly between transmit and receive if the medium 110 is a wireless medium. Such sensory webs may enable the collection and analysis of data from a large number of geographically spaced apart positions on an object or within an area.

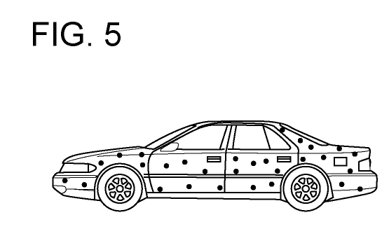

Such information may be used to, for example, derive conclusions regarding a change in environment associated with that object or area. Such sensory webs have a large number of applications, some of which examples of which are described below. However, one example, illustrated in FIG. 5, is that of a vehicle which may have potentially thousands of such nodes composed within the surface of the car body as represented by the dots on the vehicle in FIG. 5. These sensory nodes may then each determine, for example, pressure and/or temperature readings which may be communicated back through the sensory web, potentially to a centralized node which may make decisions regarding e.g., airbag deployment. Those skilled in the art will appreciate that there are numerous other applications for such technology including, for example, embedding such sensory webs with a large plurality of nodes in an aircraft or wing of an aircraft to determine measurements of stress in the material or tension. In fact, any mechanical structure which would benefit from measurement of stress, temperature, or other characteristics could have such sensory webs embedded therein.

Other applications include, for example, monitoring of critical mechanical structures (e.g., aircraft wings, cars, bridges, pipes in nuclear power stations). Occasionally, these mechanical structures are deformed in disastrous ways (aircraft wings break, cars crash, bridges fall apart and pipes break). It is valuable to know about the occurrence of such deformation a few milliseconds before the deformation takes place in order to reduce the consequences of the deformation. It is useful for example to (i) close valves in fuel distribution systems in order to reduce the risk of explosion, (ii) inflate the airbags and possible reconfigure the mechanical structures of a car in order to save human lives, and (iii) gracefully shutdown he process in a nuclear power station.

Still other applications may include, for example, monitoring physical environments for improved safety, efficiency or convenience. A combustion engine may operate more efficiently (using computer control of fuel injection) if the distribution of the concentration of a molecule (COX, NOX, SOX and fuel) or a physical quantity (e.g., temperature, pressure) is known at high resolution in space and the information is timely (e.g., millisecond old information). The process industry (for example producing steel or paper from raw materials) typically may apply heat/cooling or a chemical substance to a workpiece. It may be desired that the temperature or the concentration of the chemical substance be spread out evenly on the workpiece. Controlling such processes may benefit from knowing the distribution of such physical quantities in space. Some merchandise (e.g., food) may have to be transported and stored at low temperature. It may be useful to detect whether there is any spot where the temperature exceeds an allowed threshold (8 degrees Celsius) and find the source of the high temperature (for example a malfunctioning cooling device). Human beings are occasionally exposed to acoustic noise (for example in cars or aircrafts) but this can be reduced with so-called anti-noise. In such applications, it may be useful to know the distribution of sound as a function of time and space with high resolution in both time and space.

The above-described exemplary embodiments are intended to be illustrative in all respects, rather than restrictive, of the present invention. Thus the present invention is capable of many variations in detailed implementation that may be derived from the description contained herein by a person skilled in the art. No element, act, or instruction used in the description of the present application should be construed as critical or essential to the invention unless explicitly described as such. Also, as used herein, the article “a” is intended to include one or more items.

1. A computerized method for incrementally obtaining an interpolation of sensor readings, the method being executed on one or more processors and comprising:
broadcasting, from a node, a request to a plurality of neighboring nodes, the request triggering the plurality of neighboring nodes to contend for access to a medium to transmit information;
receiving, in the node, a priority value from each of the plurality of neighboring nodes;
determining if the node is a winning node from among the neighboring nodes based on the received priority values and a priority value of the node;
granting access to the medium to the node if it is the winning node; and
performing an action in the physical world in response to data transmitted from the node if it is the winning node,
wherein the node and each of the plurality of neighboring nodes includes at least one sensor, and
wherein the priority values of the node and of the plurality of neighboring nodes are assigned based on readings of the at least one sensors of the node and the plurality of neighboring nodes.

2. The computerized method of claim 1, wherein each of the at least one sensors transmits periodic readings.

3. The computerized method of claim 2, wherein the readings of the at least one sensors of the plurality of neighboring nodes are communicated to the node during the receiving operation.

4. The computerized method of claim 2, wherein the priority values of the node and of the plurality of neighboring nodes are measured in priority levels related to a number of bits used to represent sensor information and related to a total number of sensors.

5. The computerized method of claim 2, wherein the medium to transmit information is a wireless medium.

6. The computerized method of claim 2, wherein the medium to transmit information comprises a wireline medium.

7. The computerized method of claim 2, wherein the determining if the node is the winning node further comprises determining based on a prioritized medium access control (MAC) based on the received priority value and the received priority values.

8. The computerized method of claim 7, wherein the prioritized MAC protocol is a collision-free protocol.

9. The computerized method of claim 7, wherein the prioritized MAC protocol is a collision-not-free protocol.

10. A system for incrementally obtaining an interpolation of sensor readings, the system comprising:
a medium to transmit information;
a node including at least one sensor; and
a plurality of neighboring nodes, each including at least one sensor, wherein the node broadcasts a request to a plurality of neighboring nodes, the request triggering the plurality of neighboring nodes to contend for access to the medium to transmit information,
wherein the node receives a priority value from each of the plurality of neighboring nodes, the node determines if the node is a winning node from among the neighboring nodes based on the received priority values and a priority value of the node, access is granted to the medium to the node if the node is the winning node, and the system performs an action in the physical world in response to data transmitted from the node if it is the winning node, and
wherein the priority values of the node and of the plurality of neighboring nodes are assigned based on readings of the at least one sensors of the node and the plurality of neighboring nodes.

11. The system of claim 10, wherein each of the at least one sensors transmits periodic readings.

12. The system of claim 10, wherein the readings of the at least one sensors of the plurality of neighboring nodes are communicated to the node when the node receives the priority value from each of the plurality of neighboring nodes

13. The system of claim 10, wherein the priority values of the node and of the plurality of neighboring nodes are measured in priority levels related to a number of bits used to represent sensor information and related to a total number of sensors.

14. The system of claim 10, wherein the medium to transmit information is a wireless medium.

15. The system of claim 10, wherein the medium to transmit information comprises a wireline medium.

16. The system of claim 10, wherein the prioritized MAC protocol is a collision-free protocol.

17. The system of claim 10, wherein the prioritized MAC protocol is a collision-not-free protocol.

18. A system for incrementally obtaining an interpolation of sensor readings, the system comprising:
a medium to transmit information;
a plurality of nodes, each node including
a processor;
a memory device connected to the processor;
a sensor connected to the processor; and
a transceiver connected to the processor to transmit and receive processed sensor data via the medium to transmit information,
wherein periodic sensor readings are transmitted to the processor for processing resulting in processed sensor data,
wherein the transceiver communicates at least a portion of said processed sensor data via the medium to transmit information based on a prioritized medium access control (MAC) based on a priority,
wherein a value of said priority is assigned based on said at least a portion of the processed sensor data.

19. The system of claim 18, wherein said value of said priority is measured in priority levels related to a number of bits used to represent sensor information and related to a total number of sensors.

20. The system of claim 18, wherein the medium to transmit information is a wireless medium.

21. The system of claim 18, wherein the medium to transmit information comprises a wireline medium.

22. The system of claim 18, wherein the prioritized MAC protocol is a collision-free protocol.

23. The system of claim 18, wherein the prioritized MAC protocol is a collision-not-free protocol.

24. The system of claim 18, wherein an action in the physical world is performed in response to said at least a portion of the processed sensor data.

25. A computerized method for incrementally obtaining an interpolation of sensor readings, the method being executed on one or more processors and comprising:
using a first set of sensor readings and a first algorithm to generate a first interpolation containing a set of points S;
subsequently generating interpolations of said sensor readings by iteratively:
removing one point from the set of points S; and
adding a new point to the set of points S, wherein said new point is determined by calculating, for each of a plurality of nodes each having at least one of said sensors, an error associated with their respective sensor reading relative to a current interpolation function,
until a predetermined number of new points have been added to said set of points S to generate said interpolation of sensor readings.
